(19) United States
(12) Patent Application Publication
(10) Pub. No.: US 2017/0020151 A1
(43) Pub. Date: Jan. 26, 2017

(54) PROCESS FOR PRODUCING LACTOSE-FREE DAIRY PRODUCTS (II)

(71) Applicant: DMK Deutsches Milchkontor GmbH, Zeven (DE)

(72) Inventors: Sven-Rainer Döring, Zeven (DE); Jan Aschemann, Zeven (DE); Thorben Oehickers, Buchholz (DE)

(21) Appl. No.: 15/196,748

(22) Filed: Jun. 29, 2016

(30) Foreign Application Priority Data
Jul. 25, 2015 (EP) 15 178 394.1

(51) Int. Cl. A23C 9/12; A23C 9/15; A23C 9/142

(52) U.S. Cl. CPC A23C 9/1206; A23C 9/1422; A23C 9/1512

(57) ABSTRACT

A process for producing dairy products with a defined lactose content is suggested, comprising the following steps:
(a) Ultrafiltration of a starting milk for producing a first permeate P1 and a first retentate R1;
(b) Nanofiltration of the first permeate P1 for producing a second perorate P2 and a second retentate R2;
(c) Hydrolysis of the second retentate R2 while adding lactase;
(d) Mixing the first retentate R1 with such an amount of the second permeate P2 and the hydrolysis product of step (c) each that a standardized dairy product is obtained, the content of proteins and minerals of which corresponds to the one of the starting milk.

### FIELD OF THE INVENTION

The invention is in the field of lactose-free dairy products and relates to the production of dairy products with reduced, but defined, lactose content and a largely identical mineral composition in comparison with the starting milk, which may be converted into lactose-free products without changing the taste profile of the starting milk.

### STATE OF THE ART

During their breastfeeding period, newborn mammals create the enzyme lactase, which breaks down the disaccharide milk sugar into the sugar types D-galactose and D-glucose, which are metabolically usable. In the process of natural weaning from breast milk, the activity of lactase drops to about 5-10% of its activity at the time of birth. This applies to humans and all other mammals alike. Only in populations that had been consuming dairy for a long time a mutation became predominant which has the effect that a sufficient amount of lactase is continued to be created in adulthood (lactase persistence). It is assumed that this is caused by the higher lactase activity which provided these groups with a selective advantage (mineral substances, nutritional value).

In the case of deficient lactase activity in humans, unbroken milk sugar moves as far as the colon where it is absorbed and fermented by intestinal bacteria. Lactic acid as well as methane and hydrogen are formed as fermentation products. The gases cause, inter alia, bloating, and the osmotically active lactic acid causes an increased flow of water into the bowels (osmotic diarrhea).

In Asia and Africa, the lack of lactase persistence or lactose intolerance affects the majority of the adult population (90% or more), in Western Europe, Australia, and North America it is 5-15% (in the case of fair-skinned people). In Germany, 15-25% of the total population are estimated to suffer from a milk sugar intolerance. The reason for a lactose intolerance is a congenital enzyme deficiency, in which the relevant enzymes are missing that break down milk sugar into its components and decompose it. In the past years, at least the awareness that there is a context between the symptoms mentioned and the presence of lactose, particularly in dairy products, has strongly increased. This resulted in a great demand for products that are low in lactose, or better, lactose-free.

Various processes are known in the state of the art, by means of which lactose is either separated from dairy products and further processed as a by-product, or decomposed by adding enzymes as appropriate.

The subject matter of EP 1503630 B1 (VALIO) is, for example, a process for producing lactose-free products, wherein the starting milk is initially subjected to ultrafiltration. The first permeate obtained herein is nanofiltered, in the process of which lactose is discharged via the second retentate, and the monovalent salts (sodium, potassium) enter into the second permeate. The latter is concentrated by means of reverse osmosis and the third retentate such obtained is admixed to the first retentate again before subjecting it to hydrolysis in order to enzymatically decompose lactose. The process, however, has two substantial disadvantages: it is impossible to control the lactose content of the retentate which is hydrolyzed, as it automatically adjusts to a very low value as a result of the ultrafiltration conditions. As a result, only small amounts of sugar are available for breaking down during hydrolysis, so that a lactose-free milk is obtained, which, however, is much less sweet and has a less pleasing taste than the starting milk. Further, this process allows only alkaline salts to be fed back into the milk. In order to more or less achieve the taste profile of the original milk, divalent salts from other sources must be added again. In sum, in any case, a product is obtained which only approximately corresponds to the desired taste profile of the original milk.

A similar path is suggested in EP 2207428 B1 (ARLA): here, milk is also initially subjected to ultrafiltration, whereby the permeate is then nanofiltered. The permeate of nanofiltration is mixed with the retentate of ultrafiltration and is subsequently hydrolyzed. However, this process has the same disadvantages as the Valio process with respect to the taste profile of the resulting products.

It is therefore the object of the present invention to provide a lactose-free dairy composition on the basis of whole milk, skimmed milk, or standardized milk, which typically contains between 4 and 5% by weight lactose, which, however, possesses the same or substantially the same mineral composition as the starting milk, so that lactose-free products may be produced the taste profile of which correspond to the one of the starting milk.

### SUMMARY OF THE INVENTION

A first subject-matter of the present invention relates to a process for producing dairy products with a defined lactose content, for example, of about 0.5 to about 2.5 wt %, comprising the following steps:
(a) Ultrafiltration of a starting milk for producing a first permeate P1 and a first retentate R1;
(b) Nanofiltration of the first permeate P1 for producing a second permeate P2 and a second retentate R2 ;
(c) Hydrolysis of the second retentate R2 while adding lactase;
(d) Mixing the first retentate R1 with such an amount of the second permeate P2 and the hydrolysis product of step (c) each that a standardized dairy product is obtained, the content of proteins and minerals of which corresponds to the one of the starting milk.

In a first particular embodiment, in step (c) such an amount of lactase is applied that the amount of lactose contained in the product is completely broken down into glucose and galactose. This means that all further process steps are performed using an already lactose-free milk, the mineral concentration and composition of which must still be adapted to the ones of the starting milk.

In an alternative second embodiment, the process comprises the following further step:
(e) Hydrolysis of the standardized dairy product of step (d) while adding such an amount of lactase that the residual amount of lactose still contained in the product is completely broken down into glucose and galactose.

This embodiment of the invention takes effect in case that in step (c) an amount of lactase has been applied which is just not sufficient to break down the total amount of lactose.

Surprisingly, it was found that the process of the invention fully complies with the described requirement profile. In doing so, the milk is initially separated by ultrafiltration into a protein-rich/low-lactose and a lactose-rich/low-protein fraction. The lactose content of the latter is concentrated again using nanofiltration before it is subjected to a hydrolysis step in which a molecule of lactose is broken down into one molecule of glucose and one molecule of galactose each. Subsequently, the hydrolysis product of the protein fraction is added again while adding the permeate of nanofiltration in such amounts (“standardization”) that the protein and mineral composition of the starting milk is obtained again. Studies on the relative sweetening power (rS) of different carbohydrates based on saccharose (cf. Noeske, 1996) showed that both glucose (rS=64) and galactose (rS=60) each had about twice the sweetening power of lactose (rS=30). Preferably, the content of glucose and galactose is thus set to a value with which the sweetness of the starting milk is achieved. As a result of adding the milk's own salts to the milk instead of other salts during standardization, after hydrolysis, in sum, a product is obtained which is lactose-free, but does not differ from the starting milk in its composition, thus having the same taste impression.

Products containing less than 0.1 wt % and, preferably, less than 0.01 wt % lactose are understood to be lactose-free.

### BRIEF DESCRIPTION OF THE DRAWING

The present invention will be described in greater detail with reference to the accompanying drawing which schematically illustrates a flow chart of the present invention.

### DESCRIPTION OF THE INVENTION

Ultrafiltration

In a first process step, the starting milk, which may be whole milk, skimmed milk or standardized milk of a lactose content in the range of about 3 to about 5 wt % and, preferably, about 4 to about 4.5 wt % is separated into a protein-rich and a low-lactose fraction, and into a low-protein and a lactose-rich fraction.

Ultrafiltration belongs to the filtration processes in the field of membrane technology, by means of which macromolecular substances and small particles may be separated from a medium and concentrated. Depending on the degree of separation, microfiltration, ultrafiltration and nanofiltration are distinguished. If the exclusion limit (also called “Cut-off”) is 100 nm or more, this is referred to as microfiltration. If the exclusion limit is in the range between 2 to 100 nm, this is referred to as ultrafiltration. In the case of nanofiltration the exclusion limit is below 2 nm. Each of these cases is a purely physical, i.e. mechanical, membrane separation process functioning according to the principle of mechanical size exclusion: all particles in the fluids larger than the membrane pores are retained by the membrane. The driving force in both separation processes is the differential pressure between the inlet and the outlet of the filter surface, which is between 0.1 and 10 bar.

The exclusion limits of ultrafiltration membranes are also specified in the form of NMWC (Nominal Molecular Weight Cut-Off, also called MWCO, Molecular Weight Cut Off, unit: Dalton). It is defined as the minimum molecular weight of globular molecules which are retained to 90% by the membrane. In practice, the NMWC should be at least 20% lower than the molecular mass of the molecule to be separated. Further qualitative statements about filtration may be made using the flux (water value) (transmembrane flux or passage rate). In an ideal case, it behaves proportionally to the transmembrane pressure and reciprocally to the membrane resistance. These quantities are determined both by the properties of the membrane used and also by concentration polarization and the fouling which may occur. The passage rate is based on 1 m² membrane surface. Its unit is l/(m² h bar).

In a preferred embodiment of the process of the invention, ultrafiltration is performed while adding such an amount of diafiltration water that a first retentate with a dilution factor of about 5 to about 20 is obtained and, preferably, about 8 to 12 is obtained.

Membranes with a pore diameter in the range of about 1,000 to about 50,000 and, preferably, of about 2,000 to about 25,000 Dalton have proved to be particularly suitable for ultrafiltration. In contrast to this, for example, nanofiltration prefers pore diameters in the range of 100 to 1,000 and, preferably, about 150 to about 800 Dalton.

The material of the filter surface may be made of stainless steel, polymer materials, ceramics, aluminum oxide or textile fabric. There are different forms of filter elements: cartridge filters, flat membranes, spiral wound membranes, bag filters and hollow fiber membrane modules, which are all principally suitable within the meaning of the present invention.

However, spiral wound membranes made of polymer materials, or cartridge filters made of ceramics or aluminum oxide are preferably used, whereby the first embodiment has been proved particularly suitable for ultrafiltration and the second one for nanofiltration.

Ultrafiltration within the meaning of the present invention may be performed “hot” or “cold”, i.e. in the temperature range of about 4 to about 55° C. It is, however, preferable to operate at temperatures in a low range from about 4 to about 25° C. and, particularly, about 8 to about 18° C.

Nanofiltration

In a second process step, the permeate of ultrafiltration, which is rich in lactose, is subjected to a nanofiltration step, in which a retentate is obtained, the lactose and minerals of which are further concentrated. The permeate is more or less pure water, still containing a maximum of 0.5 wt % salts.

Nanofiltration may be performed under the same conditions and using the same components as described above. In doing so, membranes are suitable which have a pore diameter in the range of about 100 to about 1.000 Dalton and, preferably, about 150 to 250 Dalton.

Hydrolysis

Lactose belongs to the group of disaccharides and consists of the two molecules D-galactose and D-glucose, which are bonded by a β-1,4-glcosidic bond.

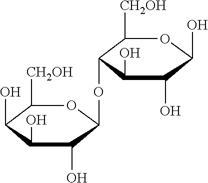

In order to perform a decomposition into the two sugar components, the enzyme lactase (also referred to as LPH or LCT) is added to lactose. Hydrolysis is, preferably, performed in a stirred tank with a continuous inlet and outlet as well as a dosing device for adding the enzyme and a valve arranged at the bottom of the reactor for discharging the deactivated enzyme which deposits in the course of time. It has proved to be advantageous to use an efficient enzyme concentration of about 180,000 to 250,000 FCC units of lactase per kg of lactose to be hydrolyzed, and to perform the reaction at temperatures in the range of about 4 to about 65° C. and, preferably, in the range of 20 to 30° C. and with a slightly acid pH value of about 5 to 6.

Mixing

The mixing step serves the production of a standardized lactose-free dairy product. In doing so, defined amounts of carbohydrates and minerals are added to the protein-rich first retentate obtained in the first step. It is particularly intended to obtain a product which has a correspondingly adapted sugar concentration relative to the starting milk in order to obtain the same sweetness. Also the addition of minerals is pursued with the goal of readjusting the original salt concentration and salt composition in order to maintain the taste impression of the original milk.

In a specific embodiment, the process of the invention is, therefore, further characterized in that
(i) such an amount of the hydrolysis product is added to the first retentate R1 that a concentration of glucose and galactose of together about 1.0 to about 3.5 wt %, preferably, about 1.5 to about 3.0 wt %—based on the resulting standard milk—is obtained and/or
(ii) such an amount of the second permeate P2 is added to the first retentate R1 that a mineral concentration of about 0.6 to about 1.0 wt %—based on the resulting standard milk—is obtained, and/or
(iii) such an amount of the second permeate P2 is added to the first retentate R1 that by this dilution a protein concentration of about 3.5 to about 4.0 wt %—based on the resulting standard milk—is obtained.

### REFERENCE SIGNS IN THE FIGURE

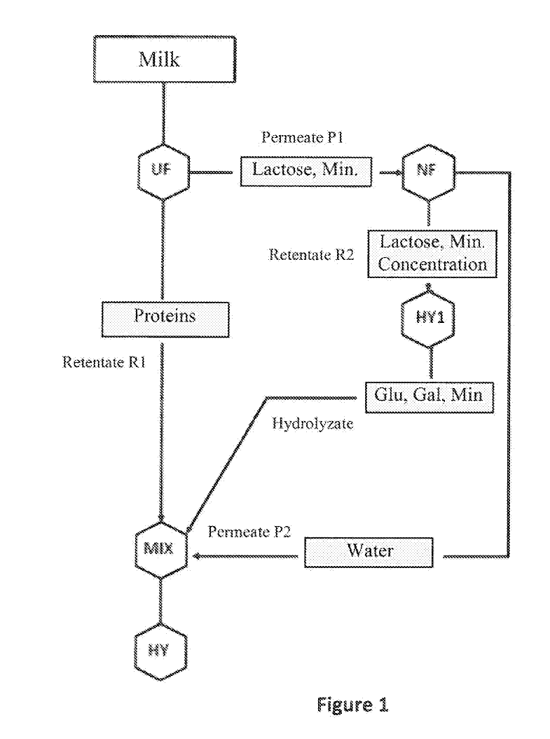

The process of the invention is schematically summarized in FIG. 1. Here, the abbreviations mean:
UF=Ultrafiltration
NF=Nanofiltration
MIX=Mixing
HY=Hydrolysis
Glu=Glucose
Gal=Galactose
Min=Minerals

### EXAMPLES

### Example 1

100 kg milk of the following composition

| MILK | Amount [wt %] |
|---|---|
| Lactose | 4.0 |
| Proteins | 3.5 |
| Minerals | 0.8 |

was subjected to a first ultrafiltration step at 10° C. while adding diafiltration water. The dilution factor was 10, whereby a protein-rich first retentate R1 was obtained as an intermediate product, having the following composition:

| RETENTATE R1 | Amount [wt %] |
|---|---|
| Lactose | 0.4 |
| Proteins | 11.0 |
| Minerals | 0.08 |

Simultaneously, a low-protein first permeate P1 was obtained, having the following composition:

| PERMEATE P1 | Amount [wt %] |
|---|---|
| Lactose | 4.0 |
| Proteins | <0.1 |
| Minerals | 0.8 |

The permeate P1 was subsequently subjected to a nanofiltration step at 10 ° C. using a membrane with a pore size of 800 Dalton, whereby a second retentate R2 of a dry matter content of about 18 wt % and the following composition was obtained:

| RETENTATE R2 | Amount [wt %] |
|---|---|
| Lactose | 13.0 |
| Proteins | <0.1 |
| Minerals | 2.0 |

Simultaneously, a second permeate P2 was obtained, consisting of water with a content of salts of 0.3 wt %.

The second retentate R2 was set to pH =6 in a stirred tank at 25° C. and an amount of lactase was added such that a concentration of about 200,000 FCC units/kg lactose was obtained. After a hydrolysis time of about 3 hours, a product was obtained, having the following composition:

| HYDROLOYSIS | |
|---|---|
| PRODUCT | Amount [wt %] |
| Lactose | <0.1 |
| Glucose | 13.0 |
| Galactose | 13.0 |
| Proteins | <0.1 |
| Minerals | 2.0 |

Subsequently, such an amount of the hydrolysis product and the second permeate P2 was added to the retentate R1 that a standardized milk of the following composition resulted:

| STANDARD MILK | Amount [wt %] |
|---|---|
| Lactose | <0.1 |
| Glucose | 1.0 |
| Galactose | 1.0 |
| Proteins | 3.5 |
| Minerals | 0.8 |

The standardized milk thus had the same content of proteins and the same amount and composition of minerals as the starting milk. The total amount of carbohydrates (glucose+galactose) was 2 wt %. In this manner, a lactose-free milk was obtained, having the same sweetness and the same taste profile as the original milk.

1. A process for producing lactose-free dairy products, comprising the following steps:
subiecting a starting milk to ultrafiltration for producing a first permeate P1 and a first retentate R1;
(b) subjecting said first permeate P1 to nanofiltration for producing a second permeate P2 and a second retentate R2;
(c) hyrdrolyzing said second retentate R2 while adding actase; and
(d) mixing said first retentate R1 with an amount of the second permeate P2 and the hydrolysis product of step (c) each such that a standardized dairy product is obtained, the content of proteins and minerals of which corresponds to the one of the starting milk.

2. The process of claim 1, comprising applying in step (c) an amount of lactase such that the amount of lactase still contained in the product is completely broken down into glucose and galactose.

3. The process of claim 1, a further comprising the step of:
(e) hydrolyzing the standardized dairy product of step (d) while adding an amount of lactase such that the residual amount of lactose still contained in the product is completely broken down into glucose and galactose.

4. The process of claim 1, comprising using as the starting milk, whole milk, skimmed milk or standard milk.

5. The process of claim at least claim 1, comprising applying a starting milk having a lactose content in the range of about 3 to about 5 wt %.

6. The process of claim 1, wherein ultrafiltration is performed using a membrane having a pore diameter of about 1,000 to about 50,000 Dalton.

7. The process of claim 1, wherein ultrafiltration is performed with a volume dilution factor in the range of 5 to about 20.

8. The process of claim 1, wherein ultrafiltration is performed with a volume dilution factor in the range of 8 to about 18.

9. The process of claim 1, wherein ultrafiltration is performed at temperatures in the range of about 4 to about 25 ° C.

10. The process of claim 1, wherein nanofiltration is performed using a membrane having a pore diameter in the range of about 100 to about 1,000 Dalton.

11. The process of claim 1, wherein nanofiltration is performed at temperatures in the range of about 4 to about 25 C.

12. The process of claim 1, comprising adding an amount of the hydrolysis product to the first retentate R1 such that a concentration of glucose and galactose of together of about 1.0 to about 3.5 wt %—based on the resulting standard milk—is obtained.

13. The process of claim 12, comprising adding such an amount of the hydrolysis product to the first retentate R1 such that a concentration of glucose and galactose together of about 1 to about 3.0 wt %—based on the resulting standard milk is obtained.

14. The process of claim 1, comprising adding an amount of the second permeate P2 to the first retentate R1 such that a mineral concentration of about 0.6 to about 1.0 wt %—based on the resulting standard milk—is obtained.

15. The process of claim 1, comprising adding an amount of the second permeate P2 to the first retentate R1 such that by this dilution a protein concentration of about 3.5 to about 4.0 wt %—based on the resulting standard milk—is obtained.
